(19) United States
(12) Patent Application Publication
(10) Pub. No.: US 2026/0229559 A1
(43) Pub. Date: Aug. 6, 2026

(54) AIRFLOW DISTRIBUTION NOZZLE FOR AIRFLOW METERS

(71) Applicant: TOYOTA MOTOR ENGINEERING & MANUFACTURING NORTH AMERICA, INC., Plano, TX (US)

(72) Inventors: Luzangelica M. Shaw, Ypsilanti, MI (US); Ryan A. Mikolaizik, Ypsilanti, MI (US); Donald E. Maynard, Ann Arbor, MI (US); Tenghua T. Shieh, Ann Arbor, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 19/042,827

(22) Filed: Jan. 31, 2025

(51) Int. Cl. H01M 8/04082; H01M 8/0438

(52) U.S. Cl. CPC H01M 8/04201; H01M 8/0438; H01M 2250/20

(57) ABSTRACT

Airflow distribution nozzles direct airflow toward a conduit's center upstream of an airflow meter, regardless of the inlet flow orientation. The flow distribution nozzle allows for any flow variation in the intake and produces more laminar flow downstream of the nozzle.

### TECHNICAL FIELD

The subject matter described herein relates generally to airflow distributors and, more particularly, to an airflow distribution nozzle for use with airflow meters.

### BACKGROUND

Generally, in fuel cell applications, the airflow around an airflow meter in a vehicle is not evenly distributed due to the air inlet shape. As a result, the airflow meter may not accurately read/sense under different temperature, pressure and flow rate conditions inside the conduit.

### SUMMARY

Accordingly, to overcome the limitations of the conventional art, the present disclosure provides airflow distribution nozzles that direct airflow toward the center of the conduit, thereby resulting in more laminar flow upstream of the airflow meter.

In general, the airflow distribution nozzles direct airflow to a conduit's center upstream of an airflow meter, regardless of the inlet flow orientation. The flow distribution nozzle allows for any flow variation in the intake and produces laminar flow downstream of the nozzle.

A generalized system includes a fuel cell and a conduit that communicates airflow to the fuel cell. An airflow meter is positioned along the conduit. A nozzle is also positioned along the conduit upstream of the airflow meter. The design of the nozzle is adapted such that airflow exiting the nozzle is directed to a center of the conduit.

In other embodiments, the nozzle is designed as a converging nozzle. In yet other embodiments, the nozzle includes a leading diameter and a trailing diameter. The leading diameter is larger than the trailing diameter.

In other embodiments, the air system in which the nozzle forms part is part of a vehicle fuel cell air system. The distance between the nozzle and airflow meter may be in the range of in the range of 50-315 mm.

In other embodiments, the airflow exits the nozzle in a way where higher velocity airflow is concentrated toward the center of the conduit and lower velocity airflow is concentrated outside the center of the conduit.

In yet other embodiments, the nozzle generates laminar airflow downstream of the nozzle.

Another generalized embodiment of the present disclosure provides a vehicle having a fuel cell and a conduit to communicate airflow to the fuel cell. An airflow meter is positioned along the conduit. A nozzle is positioned along the conduit upstream of the airflow meter, the nozzle being adapted to direct the airflow to a center of the conduit.

In yet another generalized embodiment, an airflow distribution nozzle for use in a fuel cell air system is provided. The nozzle includes a leading diameter positioned along a conduit communicating airflow therethrough, the leading diameter being adapted to receive the airflow. The nozzle also includes a trailing diameter adapted to direct the airflow received from the leading diameter to a center of the conduit before the airflow is communicated to an airflow meter positioned along the conduit.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a three-dimensional illustration of a fuel cell air system according to certain illustrative embodiments of the present disclosure.

FIG. 2A is a three-dimensional perspective view of an airflow distribution nozzle, according to certain illustrative embodiments of the present disclosure.

FIG. 2B is a sectional side-view perspective of the airflow distribution nozzle of FIG. 2A.

FIG. 2C is a front facing view of nozzle 210.

FIG. 3A is front facing sectional view of airflow along a conduit entering an airflow meter without the airflow distribution nozzle of the present disclosure.

FIG. 3B shows a target distribution of airflow around conduit 102 which gives the most efficient distribution for an airflow meter.

FIG. 3C illustrates the distribution of airflow as it exits the distribution nozzles of the present disclosure.

FIG. 4 is a diagrammatic illustration of a vehicle fuel cell air system in accordance with at least one embodiment of the present disclosure.

### DETAILED DESCRIPTION

The present disclosure is generally directed to airflow distribution nozzles for use with airflow meters. Illustrative embodiments of the present disclosure provide nozzles to re-align airflow, upstream of an airflow meter, toward the center of conduits for any airflow sensing needs such as, for example, in fuel cell applications. Generally, the airflow around an airflow meter in a vehicle is not evenly distributed due to the air inlet shape. As a result, the airflow meter may not accurately read/sense under different temperature, pressure and flow rate conditions inside the conduit. Accordingly, embodiments of the present disclosure describe air systems with in-line nozzles with particular physical characteristics that are upstream of the respective airflow meter of the system.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. It is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes, and should not be considered to limit the scope of the embodiments described herein. Certain features may be added, removed, or modified without departing from the spirit of the claimed subject matter.

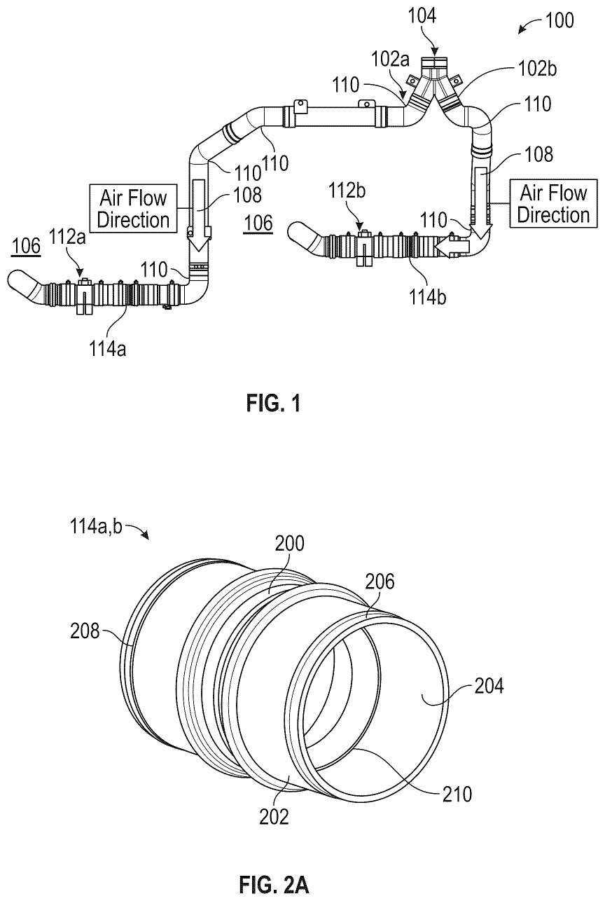

FIG. 1 is a 3D illustration of a fuel cell air system according to certain illustrative embodiments of the present disclosure. Fuel cell air system 100 is a dual-conduit design include a first conduit 102a and a second conduit 102b, each communicating airflow from an air source 104 into a fuel cell module 106. As will be described in more detail below, first and second conduits 102a,b are made up of various piping sections, elbows/bends, and other hollow-shaped components which allow airflow to be communicated therethrough. The various components forming conduits 102a,b may be coupled together using any suitable method such as, for example, welding. Air source 104 may be, for example, from the intake through an air filter. The airflow direction 108 is shown originating from air source 104, through conduits 102a,b, and into fuel cell module 106.

Conduits 102 a,b includes a number of bends/elbows 110 to affect and/or disturb flow of the airflow therethrough. Without bends 100, the airflow is generally evenly distributed across conduits 102a,b. However, when the airflow encounters bends 100, it is disturbed such that it is no longer well distributed across conduits 102a,b. This phenomena leads to poor readings downstream by airflow meters because the airflow meters generally require evenly distributed airflow for accurate readings.

Still referring to FIG. 1, a first airflow meter 112a is positioned along conduit 102a, while a second airflow meter 112b is positioned along conduit 102b. Airflow meters 112a,b measures the airflow as it passes through airflow meters 112a,b and electronically communicates that data to a fuel cell controller (not shown). Although airflow meters 112a,b measures the rate at which air is entering fuel cell 106 in this example, in other examples the airflow meters may serve other objections such as, for example, to measure the mass of air in a fuel cell's intake system to ensure the correct air-to-fuel ratio for chemical reaction. As such, embodiments of the present disclosure are not limited to fuel cell applications. Rather, the illustrative embodiments of the nozzles described herein may be used in any application in which airflow meters are used.

A first airflow distribution nozzle 114a is positioned in-line along conduit 102a upstream of airflow meter 112a. A second airflow distribution nozzle 114b is positioned in-line along conduit 102b upstream of airflow meter 112b. As the airflow is communicated through conduits 102a,b, it is disturbed upstream of nozzles 114a,b by the various conduit elbows 110. As the disturbed airflow encounters nozzles 144,b and flows therethrough, the design of nozzles 114a,b directs the disturbed airflow back toward the center of conduits 102a,b, thereby generating a laminar (e.g., generally evenly distributed airflow across the conduit) airflow before that airflow encounters airflow meters 112a,b. Thereafter, the airflow exiting airflow meters 112a,b, the airflow then enters fuel cell module 106.

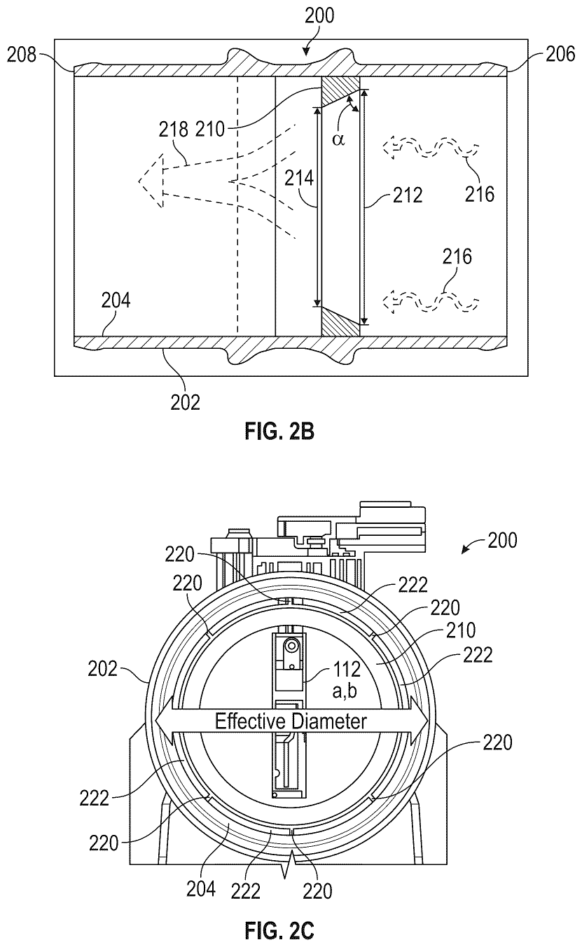

FIG. 2A is a three-dimensional perspective view of an airflow distribution nozzle, according to certain illustrative embodiments of the present disclosure. In this example, airflow distribution nozzle 114 is comprised of a tube-shaped body 200 having an outer surface 202 and inner surface 204. Body 200 also includes a leading end 206 and trailing end 208. Leading end 206 is the airflow entry side, while trailing end 208 is the airflow exit side of body 200 which communicates the airflow to the downstream airflow meter. A nozzle 210 is positioned inside body 200 and secured to inner surface 204. Nozzle 210 may be secured to inner surface 204 in a variety of ways including, for example, welding, molding, adhesive, etc.

FIG. 2B is a sectional side-view perspective of the airflow distribution nozzle of FIG. 2A. In this example, nozzle 210 is a converging nozzle, meaning that shape of nozzle 210 converges toward the center of body 200. Nozzle 210 includes a leading diameter 212 which is first encountered by the airflow as it enters nozzle 210. Nozzle 210 also includes a trailing diameter 214 which is smaller than leading diameter 212. As such, the design of nozzle 210 is one that converges from larger leading diameter 212 down to smaller trailing diameter 214. In this illustrative embodiment, the angle α of nozzle 210 may be, for example, in the range of 55-75 degrees, as shown.

As the airflow originates from source 104 and enters conduits 102a,b, it encounters various bends/elbows 110 which results is turbulent airflow 216 (airflow which is non-laminar or flowing in various directions). As turbulent airflow 216 encounters the convergent shaped nozzle 210, airflow 216 is directed toward the center of body 200 (i.e., center of the conduit), thereby resulting in a more laminar airflow 218 exiting body 200. Accordingly, nozzle 210 is used to direct airflow to the center of the conduit, upstream of the airflow meter(s), regardless of the inlet flow orientation.

FIG. 2C is a front facing sectional view of nozzle 210. In this example, nozzle 210 is attached to inner surface 204 of body 200 via a plurality of fins 220, thus forming a series of gaps 222 between nozzle 210 and surface 204. Further, in this example, the effective diameter of body 200 is in the range of 60-85 mm. However, those ordinarily skilled in the art having the benefit of this disclosure realize any variety of dimensions can be used without departing from the spirit of the embodiments discussed herein. Airflow meter 112a,b can also be seen positioned inside the tubular body as discussed with respect to FIG. 1.

The effective distance between the airflow meter and nozzle can also be varied. For example, with reference to FIGS. 1 and 2B, the effective distance between trailing diameter 214 of nozzle 210 and the airflow meter 112 a,b can be in the range of 50-315 mm in some examples. Those ordinarily skilled in the art having the benefit of this disclosure will realize the effective distance may be modified by any number of factors (e.g., size of the tubular conduit, airflow speed, etc). Ultimately, the optimal distance between the airflow meter and nozzle is the distance that results in the most laminar flow centralized in the conduit entering the airflow meter.

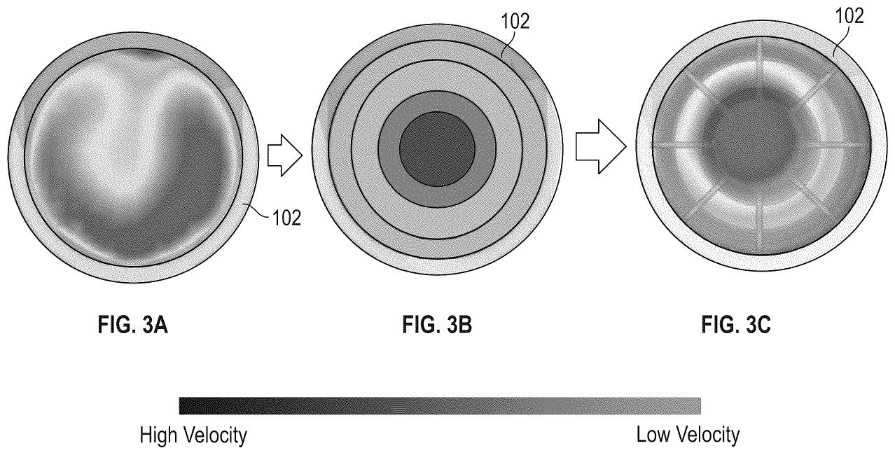

FIG. 3A is front facing sectional view of airflow along a conduit entering an airflow meter without the airflow distribution nozzle of the present disclosure. The airflow inside conduit 102 is illustrated using a velocity scale. As one can see in FIG. 3A, the higher velocity airflow is shown unevenly distributed around conduit 102, while the lower velocity airflow is shown near the center of conduit 102 and at some outer bands of conduit 102. This airflow profile results in the poor airflow metering—i.e., the airflow meter fails to read accurately under different temperature, pressure and flow rate conditions.

FIG. 3B shows a target distribution of airflow around conduit 102 which gives the most efficient distribution for an airflow meter. As can be seen, the higher velocity airflow is near the center of conduit 102, while the lower velocity airflow flows along the outer bands.

FIG. 3C illustrates the distribution of airflow as it exits the distribution nozzles of the present disclosure. As can be seen, the higher velocity airflow is concentrated near the center of conduit 102, while the lower velocity airflow is along the outer bands of conduit 102—resulting in a more laminar flow vs that of FIG. 3A. As a result, both flow velocity distribution and pressure loss needs/issues are solved using the illustrative nozzles.

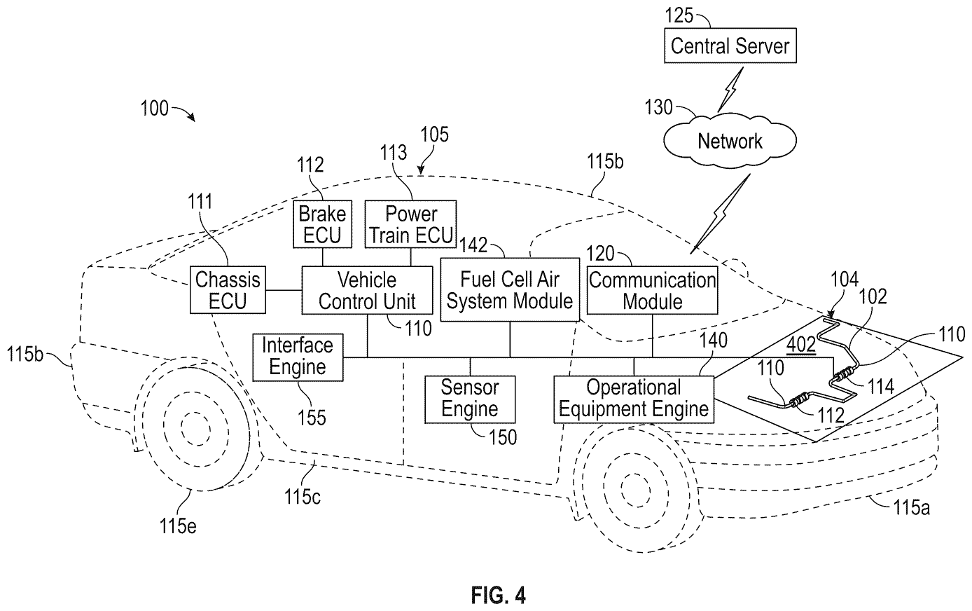

FIG. 4 is a diagrammatic illustration of a vehicle fuel cell air system in accordance with at least one embodiment of the present disclosure. In an example, a vehicle fuel cell air system is referred to by the reference numeral 100 and includes a vehicle 105, such as a car, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e.

A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information.

An operational equipment engine 140 is operably coupled to, and adapted to be in communication with, the vehicle control unit 110 and fuel cell air system module 142, which is utilized to perform the methods described herein. Fuel cell air system module 142 is also communicably coupled to fuel cell module 402 (e.g., fuel cell module 106 of FIG. 1). As can also be seen, airflow source 104, conduit 102, airflow distribution nozzle 114 and an airflow meter 112 are shown for illustration purposes. A sensor engine 150 is operably coupled to, and adapted to be in communication with, the vehicle control unit 110. The fuel cell air system module 142 is adapted to monitor and control operations of fuel cell module 402 and various other components of, for example, the operational equipment engine 140.

An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of hydrogen consumption analysis system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor and drivetrain, and sensor engine 150.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110. In addition, vehicle 105 may include any variety of processor(s), memories, non-transitory computer program products necessary to functionality of the present disclosure.

These and other advantages will be readily apparent to those ordinarily skilled in the art having the benefit of this disclosure.

Methods and embodiments described herein further relate to any one or more of the following paragraphs:
1. A fuel cell air system, comprising: a fuel cell; a conduit to communicate airflow to the fuel cell; an airflow meter positioned along the conduit; and a nozzle positioned along the conduit upstream of the airflow meter, the nozzle being adapted to direct the airflow to a center of the conduit.
2. The system as defined in paragraph 1, wherein the nozzle is a converging nozzle.
3. The system as defined in paragraphs 1 or 2, wherein the nozzle comprises: a leading diameter; and a trailing diameter, wherein the leading diameter is larger than the trailing diameter.
4. The system as defined in any of paragraphs 1-3, wherein the fuel cell air system forms part of a vehicle fuel cell air system.
5. The system as defined in any of paragraphs 1-4, wherein a distance between the airflow meter and nozzle is in the range of 50-315 mm.
6. The system as defined in any of paragraphs 1-5, wherein the airflow exits the nozzle such that: higher velocity airflow is concentrated toward the center of the conduit; and lower velocity airflow is concentrated outside the center of the conduit.
7. The system as defined in any of paragraphs 1-6, wherein the nozzle generates laminar airflow downstream of the nozzle.
8. A vehicle, comprising: a fuel cell; a conduit to communicate airflow to the fuel cell; an airflow meter positioned along the conduit; and a nozzle positioned along the conduit upstream of the airflow meter, the nozzle being adapted to direct the airflow to a center of the conduit.
9. The vehicle as defined in paragraph 8, wherein the nozzle is a converging nozzle.
10. The vehicle as defined in paragraphs 8 or 9, wherein the nozzle comprises: a leading diameter; and a trailing diameter, wherein the leading diameter is larger than the trailing diameter.
11. The vehicle as defined in any of paragraphs 8-9, wherein the fuel cell air system forms part of a vehicle fuel cell air system.
12. The vehicle as defined in any of paragraphs 8-11, wherein a distance between the airflow meter and nozzle is in the range of 50-315 mm.
13. The vehicle as defined in any of paragraphs 8-12, wherein the airflow exits the nozzle such that: higher velocity airflow is concentrated toward the center of the conduit; and lower velocity airflow is concentrated outside the center of the conduit.
14. The vehicle as defined in any of paragraphs 8-13, wherein the nozzle generates laminar airflow downstream of the nozzle.
15. An airflow distribution nozzle for use in a fuel cell air system, the nozzle comprising: a leading diameter positioned along a conduit communicating airflow therethrough, the leading diameter being adapted to receive the airflow; and a trailing diameter adapted to direct the airflow received from the leading diameter to a center of the conduit before the airflow is communicated to an airflow meter positioned along the conduit.
16. The airflow distribution nozzle as defined in paragraph 15, wherein the nozzle is a converging nozzle.
17. The airflow distribution nozzle as defined in paragraphs 15 or 16, wherein the trailing diameter is smaller than the leading diameter.
18. The airflow distribution nozzle as defined in any of paragraphs 15-17, wherein the fuel cell air system forms part of a vehicle fuel cell air system.
19. The airflow distribution nozzle as defined in any of paragraphs 15-18, wherein the airflow exits the nozzle such that: higher velocity airflow is concentrated toward the center of the conduit; and lower velocity airflow is concentrated outside the center of the conduit.
20. The airflow distribution nozzle as defined in any of paragraphs 15-19, wherein the nozzle generates laminar airflow downstream of the nozzle.

Moreover, the methods described herein may be embodied within a system comprising processing circuitry to implement any of the methods, or a in a non-transitory computer-readable medium comprising instructions which, when executed by at least one processor, causes the processor to perform any of the methods described herein.

The technology described herein may be implemented on manually controlled vehicles or driver-assist vehicles. The technology may be implemented in diverse combinations of hardware, software, and firmware, depending on the implementation or as necessitated by the structures and modules already present in existing vehicles. The system may be employed on vehicles with automatic transmission, manual transmissions, or vehicles with simulated shifting, including continuously variable transmission (CVT), infinitely variable transmission (IVT), hybrid transmissions (e.g., a hybrid vehicle with 4-speed automatic transmission simulating 10 gears), and fully electric vehicles.

Accordingly, the logical operations making up the embodiments of the technology described herein may be referred to variously as operations, steps, blocks, objects, elements, components, or modules. Furthermore, it should be understood that these may occur or be arranged in any order, unless explicitly claimed otherwise or a specific order is necessitated by the claim language or by the nature of the component or step.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cargo seat adjustment system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

The above specification, examples and data provide a complete description of the structure and use of exemplary embodiments of the systems as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter. Additionally, sensors external to the vehicle may be employed to provide or supplement any of the sensor data described hereinabove. Alternatively, machine learning algorithms or other AI systems may be used to estimate variables from sparse, noisy, or entwined data streams without departing from the spirit of the present disclosure.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A fuel cell air system, comprising:
a fuel cell;
a conduit to communicate airflow to the fuel cell;
an airflow meter positioned along the conduit; and
a nozzle positioned along the conduit upstream of the airflow meter, the nozzle being adapted to direct the airflow to a center of the conduit.

2. The system as defined in claim 1, wherein the nozzle is a converging nozzle.

3. The system as defined in claim 1, wherein the nozzle comprises:
a leading diameter; and
a trailing diameter,
wherein the leading diameter is larger than the trailing diameter.

4. The system as defined in claim 1, wherein the fuel cell air system forms part of a vehicle fuel cell air system.

5. The system as defined in claim 1, wherein a distance between the airflow meter and nozzle is in a range of 50-315 mm.

6. The system as defined in claim 1, wherein the nozzle has an effective angle in a range of 55-75 degrees.

7. The system as defined in claim 1, wherein the airflow exits the nozzle such that:
higher velocity airflow is concentrated toward the center of the conduit; and
lower velocity airflow is concentrated outside the center of the conduit.

8. The system as defined in claim 1, wherein the nozzle generates laminar airflow downstream of the nozzle.

9. A vehicle, comprising:
a fuel cell;
a conduit to communicate airflow to the fuel cell;
an airflow meter positioned along the conduit; and
a nozzle positioned along the conduit upstream of the airflow meter, the nozzle being adapted to direct the airflow to a center of the conduit.

10. The vehicle as defined in claim 9, wherein the nozzle is a converging nozzle.

11. The vehicle as defined in claim 9, wherein the nozzle comprises:
a leading diameter; and
a trailing diameter,
wherein the leading diameter is larger than the trailing diameter.

12. The vehicle as defined in claim 9, wherein the fuel cell air system forms part of a vehicle fuel cell air system.

13. The vehicle as defined in claim 9, wherein a distance between the airflow meter and nozzle is in a range of 50-315 mm.

14. The vehicle as defined in claim 9, wherein the nozzle has an effective angle in a range of 55-75 degrees.

15. The vehicle as defined in claim 9, wherein the airflow exits the nozzle such that:
higher velocity airflow is concentrated toward the center of the conduit; and
lower velocity airflow is concentrated outside the center of the conduit.

16. The vehicle as defined in claim 9, wherein the nozzle generates laminar airflow downstream of the nozzle.

17. An airflow distribution nozzle for use in a fuel cell air system, the nozzle comprising:
a leading diameter positioned along a conduit communicating airflow therethrough, the leading diameter being adapted to receive the airflow; and
a trailing diameter adapted to direct the airflow received from the leading diameter to a center of the conduit before the airflow is communicated to an airflow meter positioned along the conduit.

18. The airflow distribution nozzle as defined in claim 17, wherein the trailing diameter is smaller than the leading diameter.

19. The airflow distribution nozzle as defined in claim 17, wherein the fuel cell air system forms part of a vehicle fuel cell air system.

20. The airflow distribution nozzle as defined in claim 17, wherein the nozzle generates laminar airflow downstream of the nozzle.
